(19) United States
(12) Patent Application Publication
(10) Pub. No.: US 2016/0248615 A1
(43) Pub. Date: Aug. 25, 2016

(54) Frequency Estimation

(71) Applicant: TELEFONAKTIEBOLAGET L M ERICSSON (PUBL), Stockholm (SE)

(72) Inventors: Yi-Pin Eric Wang, Fremont, CA (US); Bo Hagerman, Tyresö (SE); Ali S. Khayrallah, Mountain View, CA (US); Michael Samuel Bebawy, Santa Clara, CA (US); Leif Wilhelmsson, Dalby (SE)

(21) Appl. No.: 14/888,473

(22) PCT Filed: May 6, 2015
(86) PCT No.: PCT/SE2015/050498

§ 371 Date: Nov. 2, 2015

Related U.S. Application Data
(60) Provisional application No. 62/052,434, filed on Sep. 18, 2014.

(51) Int. Cl. H04L 27/26; H04B 1/04; H04W 72/04

(52) U.S. Cl. CPC H04L 27/2665; H04W 72/0446; H04B 1/0475; H04L 2025/03394

(57) ABSTRACT

A frequency deviation estimator (20, 40) estimates an instantaneous frequency deviation in a received signal that includes pilot sub-blocks non-contiguously distributed in time across a radio block. Each pilot sub-block comprising one or more pilot symbols. The estimator (20, 40) is configured to select, from the pilot sub-blocks non-contiguously distributed in time across the radio block, a particular pilot sub-block for which to obtain an instantaneous frequency deviation estimate. The estimator (20, 40) applies a Fast Fourier Transform (FFT) or a Discrete Fourier Transform (DFT) to a set of contiguous received signal samples that spans multiple ones of the pilot sub-blocks, including the particular pilot sub-block as well as one or more assisting pilot sub-blocks neighboring that particular pilot sub-block. The estimator (20, 40) then obtains an instantaneous frequency deviation estimate for the particular pilot sub-block based on the resulting FFT or DFT outputs.

### RELATED APPLICATIONS

The present application claims benefit of U.S. Provisional Application 62/052,434, filed 18 Sep. 2014 and entitled “Frequency Estimation,” the disclosure of which is incorporated herein by reference in its entirety.

### TECHNICAL FIELD

The present application generally relates to estimating an instantaneous frequency deviation in a received signal.

### BACKGROUND

In wireless communication systems, transmitters are required for several reasons to up-convert the transmit signal frequency to a frequency band called the passband which is much higher than the signal's original bandwidth. The value by which the signal's frequency is shifted is called the “carrier frequency”. At the receive side, the inverse operation is required; down-converting the receive signal back from the passband to the baseband for further processing that extracts the intelligence signal from it.

For these up- and down-conversions, the transmitter and the receiver contain oscillator blocks that generate the carrier. Ideally, these two oscillators must be in perfect frequency and phase synchronism. However in several practical situations, there could be a relatively large difference between the oscillators' frequencies, which is termed the ‘frequency offset’ or “frequency deviation”. The effect of this frequency offset can be looked at as if the receive signal was multiplied by a complex exponential rotating in time with a frequency equal in value to this offset. If the value of this offset is large enough with respect to the symbol rate, the induced rotation renders it impossible to recover the information carried on the signal. For this reason, frequency estimation at the receiver is required to compensate for this offset or equivalently, the induced rotation. Furthermore, the frequency difference between the transmit and receive oscillators may not be constant. The transmitter's and/or the receiver's carrier frequency may be drifting in time. In this case, a single frequency estimate is not enough, but rather the estimation process has to be updated periodically to provide some sort of tracking of the instantaneous frequency value.

### SUMMARY

One or more embodiments herein include methods to estimate the instantaneous frequency deviation in a received signal. The methods estimate the instantaneous frequency deviation by applying a Fast Fourier Transform (FFT), or discrete Fourier Transform (DFT), to samples of the received signal. The methods in this regard notably (i) use pilot symbols that are non-contiguously distributed in time across a radio block; and/or (ii) phase-rotate the samples according to one or more properties of the received signal's modulation scheme (e.g., modulation index).

Some embodiments, for example, include a first method for estimating an instantaneous frequency deviation in a received signal that includes pilot sub-blocks non-contiguously distributed in time across a radio block. Each pilot sub-block comprising one or more pilot symbols. The method comprises selecting, from the pilot sub-blocks non-contiguously distributed in time across the radio block, a particular pilot sub-block for which to obtain an instantaneous frequency deviation estimate. The method also comprises applying a Fast Fourier Transform (FFT) or a Discrete Fourier Transform (DFT) to a set of contiguous received signal samples that spans multiple ones of the pilot sub-blocks, including the particular pilot sub-block as well as one or more assisting pilot sub-blocks neighboring that particular pilot sub-block. The method further includes obtaining an instantaneous frequency deviation estimate for the particular pilot sub-block based on the resulting FFT or DFT outputs.

In one or more embodiments, the first method also includes dynamically controlling an accuracy of the instantaneous frequency deviation estimate for the particular pilot sub-block by dynamically selecting at least one of: (1) the number of the one or more assisting pilot sub-blocks, (2) a size of the FFT or DFT; and (3) a length of each pilot sub-block. In one embodiment, for example, this dynamic selection is performed based on comparing a length of the particular pilot sub-block to a previous estimate of instantaneous frequency deviation in the received signal.

In some embodiments, the one or more assisting pilot sub-blocks comprises multiple assisting pilot sub-blocks centered around the particular pilot sub-block in time, including at least one assisting pilot sub-block on each side of the particular pilot sub-block.

Alternatively or additionally, the instantaneous frequency deviation estimate for the particular pilot sub-block is in some embodiments a periodical estimate that is obtained according to a periodogram algorithm.

In one or more embodiments, the first method entails obtaining an instantaneous frequency deviation estimate for each of multiple non-contiguous pilot sub-blocks in the radio block. The method does so by performing the above-described selecting, applying, and obtaining for each of those pilot sub-blocks. In this case, the method may further involve interpolating, from the instantaneous frequency deviation estimates obtained for the multiple non-contiguous pilot sub-blocks, an instantaneous frequency deviation estimate for each of one or more non-pilot sub-blocks that are interlaced in time between those multiple non-contiguous pilot sub-blocks.

Alternatively or additionally, the first method further includes smoothing instantaneous frequency deviation estimates obtained for sub-blocks in the radio block using a median filter, as needed to mitigate noise in those estimates.

In some embodiments, the first method further comprises phase-rotating the set of contiguous received signal samples according to one or more properties of the received signal's modulation scheme and a value of one or more pilot symbols within the set. In this case, the above-described applying step involves applies the FFT or DFT to the set, as phase rotated. In one embodiment, for example, this phase-rotating comprises determining a phase by which to rotate a received signal sample based on a nominal frequency deviation or nominal modulation index of the received signal's modulation scheme.

Other embodiments herein include a second method for estimating an instantaneous frequency deviation in a received signal. The method includes phase-rotating a set of contiguous received signal samples according to one or more properties of the received signal's modulation scheme and a value of one or more pilot symbols within the set. The method further comprises applying a Fast Fourier Transform (FFT) or a Discrete Fourier Transform (DFT) to the set of contiguous received signal samples, as phase rotated. The method then includes obtaining an instantaneous frequency deviation estimate in the received signal based on the resulting FFT or DFT outputs.

In one or more embodiments, these one or more properties include a modulation index of the received signal's modulation scheme.

Alternatively or additionally, the modulation scheme in some embodiments is continuous phase frequency shift keying (CPFSK). In this case, the one or more pilot symbols may be indexed in order with an index n, and the phase-rotating may entail multiplying the set by a complex exponential e^{-j2πf}^{_{d}}^{T}^{_{S}}^{c}^{ₚ}⁽ⁿ⁾. Here, f_{d} is a nominal frequency deviation of an CPFSK modulator, T_{S} is a duration of any given symbol in the set, and cₚ(n) is an accumulative sum of the value of said one or more pilot symbols up until symbol n.

In some embodiments, the applying described above for the first and/or second method produces L_{F} FFT or DFT output values \vec{S}_{k,1} . . . \vec{S}_{k,L}_{_{F}} corresponding respectively to L_{F} frequency deviation hypotheses \hat{f}₁ . . . \hat{f}_{L}_{_{F}}, where the frequency deviation hypotheses respectively equal (−L_{F}/2+1)*df, (−L_{F}/2+2)*df, . . . , −df, 0, df, 2df, . . . , (L_{F}/2)*df, where df=Rs/L_{F}, and Rs is the data rate of the received symbols. In this case, the obtaining described above for the first and/or second method comprises selecting from the frequency deviation hypotheses the hypothesis corresponding to the output value that has the largest absolute value or absolute value squared.

Alternatively or additionally, the first and/or second method further includes compensating for the estimated instantaneous frequency deviation in the received signal and outputting the compensated signal to a frontend demodulator.

In the first and/or second method, the received signal may be a Bluetooth Long Range (BLR) signal.

Embodiments herein further include a frequency deviation estimator configured to implement any of the first and/or second methods described above. Embodiments herein also include a receiver comprising such a frequency deviation estimator.

Embodiments also include a computer program comprising instructions, which, when executed by at least one processor of a frequency deviation estimator, causes the program to carry out any of the methods described above. Embodiments herein further include a carrier containing such a computer program, where the carrier is one of an electronic signal, optical signal, radio signal, or computer readable storage medium.

Estimating the instantaneous frequency deviation as described herein proves particularly useful, for example, in communication systems where the effect of frequency offset/drift is quite pronounced, e.g., due to the use of cheap radio frontends. Exemplary communication systems in this regard include systems that employ Bluetooth or Bluetooth Long Range (BLR). Systems based on Bluetooth or BLR allow frequency offsets up to ±150 kHz and frequency drifts up to ±50 kHz with a drift rate of up to ±400 Hz/μs. With the receive signal's frequency deviation estimated according to embodiments herein, the large frequency deviation in these systems can be compensated for so as to mitigate frequency impairments.

### BRIEF DESCRIPTION OF THE DRAWINGS

FIG. 1 is a block diagram of a distributed pilot scheme according to one or more embodiments herein.

FIG. 2 is a logic flow diagram of a method for estimating an instantaneous frequency deviation in a received signal according to one or more embodiments herein.

FIG. 3 is a block diagram illustrating one example of estimating an instantaneous frequency deviation for a particular pilot sub-block using multiple assisting pilot sub-blocks centered around that particular pilot sub-block.

FIG. 4 is a block diagram of a frequency deviation estimator implementing the method of FIG. 2, according to one or more embodiments herein.

FIG. 5 is a block diagram illustrating one approach for iterating over a radio block so as to obtain one instantaneous frequency deviation estimate for each pilot sub-block, according to one or more embodiments.

FIG. 6 is a block diagram illustrating one approach for estimating the instantaneous frequency deviation for non-pilot symbols within a radio block from the instantaneous frequency deviation estimates obtained for the pilot symbols distributed throughout that block, according to one or more embodiments.

FIG. 7 is a logic flow diagram of a method for estimating an instantaneous frequency deviation in a received signal according to one or more other embodiments herein.

FIG. 8 is a block diagram of a frequency deviation estimator implementing the method of FIG. 7, according to one or more embodiments herein.

FIG. 9 is a block diagram of a frequency deviation estimator implementing the combined methods of FIGS. 2 and 7, according to one or more embodiments herein.

FIG. 10 is a block diagram of one way to implement the frequency deviation estimator shown in FIG. 9.

FIG. 11 is a block diagram of a receiver that includes a frequency deviation estimator according to one or more embodiments.

### DETAILED DESCRIPTION

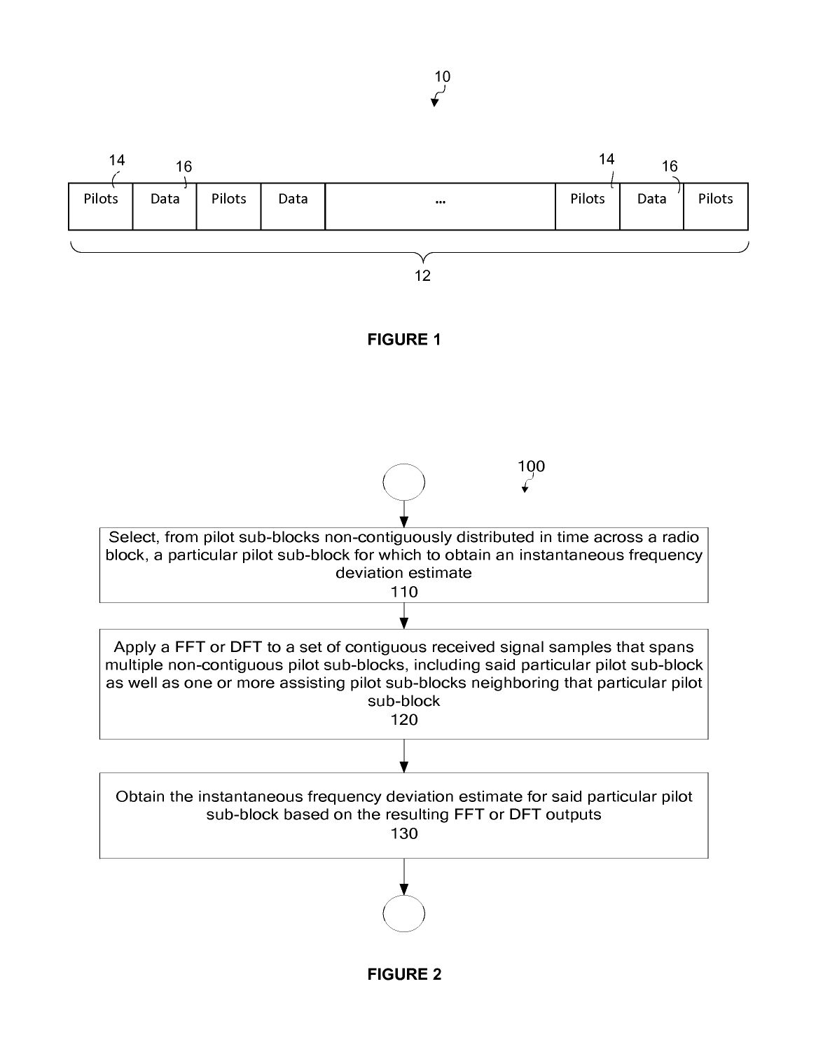

FIG. 1 illustrates a distributed pilot scheme 10 according to one or more embodiments. In a distributed pilot scheme 10, multiple pilot symbols are distributed non-contiguously in time across a radio unit or block 12 (e.g., a time slot, a burst, a subframe). As shown, a radio block 12 includes multiple, non-continuous pilot sub-blocks 14 that each comprise one or more pilot symbols. These pilot sub-blocks 14 are shown as being interlaced in the radio block 10 together with data sub-blocks 16 that each comprise one or more data symbols. However, the pilot sub-blocks 14 maybe interlaced with any non-pilot sub-blocks in other embodiments.

FIG. 2 shows one embodiment of a method 100 (e.g., implemented by an estimator of a receiver) for estimating the instantaneous frequency deviation in a received signal that includes pilot symbols non-contiguously distributed in time across a radio block 12 (e.g., using the distributed pilot scheme 10 of FIG. 1). As shown, the method 100 includes selecting, from the pilot sub-blocks non-contiguously distributed in time across the radio block 12, a particular pilot sub-block 14 for which to obtain an instantaneous frequency deviation estimate (Block 110). The method 100 further includes applying a Fast Fourier Transform (FFT) or Discrete Fourier Transform (DFT) to a set of contiguous received signal samples that spans multiple non-contiguous pilot sub-blocks 14, including the particular pilot sub-block 14 as well as one or more other pilot sub-blocks 14 (called “assisting pilot sub-blocks”) neighboring that particular pilot sub-block 14 (Block 120). The method 100 also entails obtaining the instantaneous frequency deviation estimate for the particular pilot sub-block 14 (e.g., at the center of that sub-block) based on the resulting FFT or DFT outputs (Block 130).

The one or more neighboring pilot sub-blocks 14 included within the set of samples advantageously assist with frequency deviation estimation for the particular pilot sub-block 14 so as to improve the quality of the estimate. In fact, the method 100 in one or more embodiments further includes dynamically adjusting or otherwise controlling the accuracy of the instantaneous frequency deviation estimate for the particular pilot sub-block 14. In one embodiment, for example, the method 100 does so by controlling (i.e., selecting) the number of assisting pilot sub-blocks considered in obtaining each estimate. Additional or alternative accuracy controlling criteria in this regard include the size of the FFT or DFT and/or the length of each pilot sub-block. If the length of any given pilot sub-blocks is relatively short (e.g., compared to the instantaneous frequency deviation as previously estimated), for instance, the method 100 may involve increasing the number of assisting pilot sub-blocks considered in obtaining each estimate, in order to improve the estimate accuracy. The method 100 thereby proves flexible in its complexity/accuracy to accommodate various radio conditions. In systems where frequency drift is relatively slow, the closely spaced estimates are not required, which reduces the frequency of running the estimation algorithm and vice versa. Of course, the FFT implementation of the method 100 is particularly efficient for reducing complexity in and of itself.

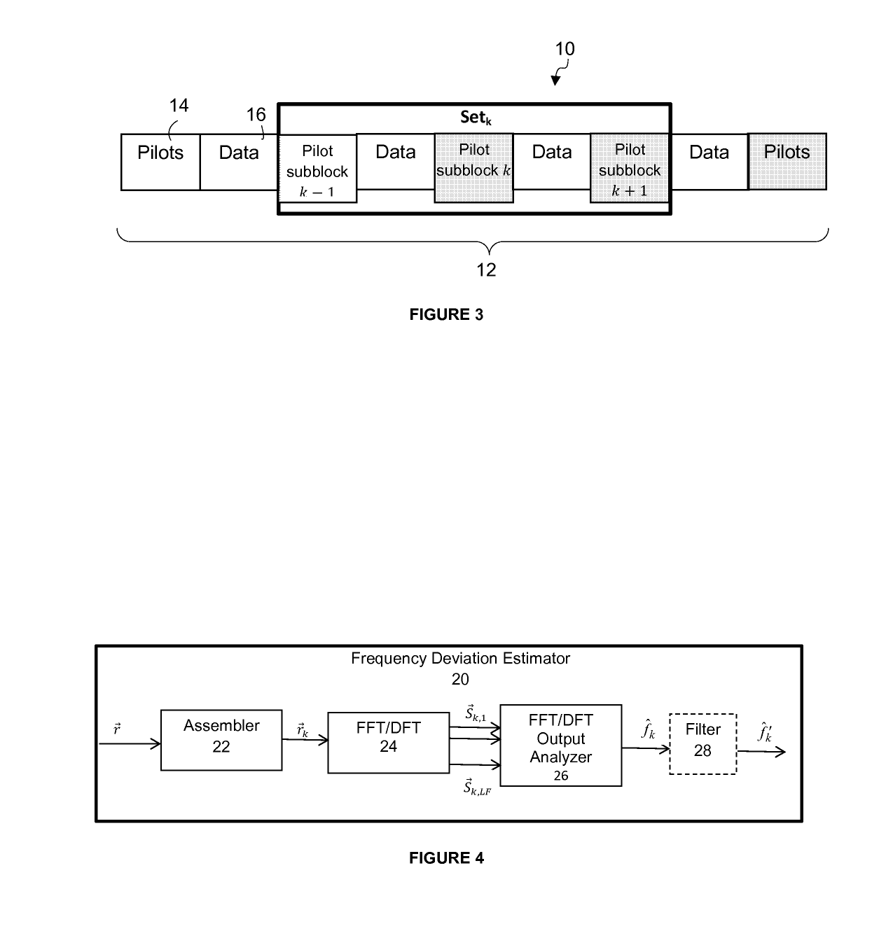

In at least some embodiments, the set of contiguous samples to which the FFT or DFT is applied spans multiple assisting pilot sub-blocks 14 centered around the particular pilot sub-block for which the instantaneous frequency is estimated. The set (i.e., collection or block) may include any number Nₚ>0 of assisting pilot sub-blocks 14 on either side of the particular pilot sub-block. FIG. 3 shows just one example of this using the distributed pilot scheme 10 of FIG. 1, where the instantaneous frequency deviation is estimated for a particular pilot sub-block k. As shown, the instantaneous frequency deviation is estimated using a set (Setₖ) that spans Nₚ=1 assisting pilot sub-blocks on either side of the particular pilot sub-block k, including sub-blocks k−1 and k+1.

Regardless, FIG. 4 illustrates a frequency deviation estimator 20 of a receiver implementing the method 100 of FIG. 2 according to at least some embodiments. As shown, the frequency deviation estimator 20 includes an assembler 22, an FFT or DFT 24, and an FFT or DFT output analyzer 26. The assembler 22 receives the receive symbol vector as \vec{r}=[\vec{r}_{p,1}, \vec{r}_{d,1}, \vec{r}_{p,2}, \vec{r}_{d,2}, . . . ]. The assembler 22 identifies the particular pilot sub-block 14 for which the instantaneous frequency deviation is to be estimated as being pilot sub-block k, and assembles a set (or block) of receive symbols \vec{r}ₖ for such estimation. The set \vec{r}ₖ is the vector of received symbols starting from pilot sub-block k−Nₚ to pilot sub-block k+Nₚ as shown in FIG. 3 for Nₚ=1. In at least some embodiments, since the data values in between the pilot sub-blocks are unknown, they are replaced by zeros. That is, in at least some embodiments, the assembler 22 assembles the set as \vec{r}ₖ=[\vec{r}_{p,k-N}_{ₚ}, \vec{0}, . . . , \vec{0}, \vec{r}_{p,k}, \vec{0}, . . . , \vec{0}, \vec{r}_{p,k+N}_{ₚ}]. In any event, if the pilot and data sub-blocks have lengths L_{P} and L_{D} respectively, \vec{r}ₖ has a length Lᵣ=(2Nₚ+1)×Lₚ+2NₚL_{D}.

The FFT/DFT 24 applies a FFT or DFT to the set 6 as \vec{r}ₖ=FFT_{L}_{_{f}}(rₖ). The applied FFT or DFT 24 has a length L_{F} so as to produce L_{F} output values \vec{S}_{k,1} . . . \vec{S}_{k,L}_{_{F}}. In at least some embodiments, the length L_{F} is selected to be sufficiently large (e.g., 1024) to decrease the frequency granularity and improve resolution. In any event, the FFT/DFT Output Analyzer 26 effectively treats each of the L_{F} output values \vec{S}_{k,1} . . . as decision metrics corresponding respectively to L_{F} frequency deviation hypotheses \hat{f}₁ . . . \hat{f}_{L}_{_{F}}. These frequency deviation hypotheses in at least some embodiments are (−L_{F}/2+1)*df, (−L_{F}/2+2)*df, −df, 0, df, 2df, . . . , (L_{F}/2)*df, where df=Rs/L_{F}, and Rs is the data rate of the received symbols. For Bluetooth Long Range, Rs=1 MHz, and thus df is 1/L_{F} MHz. Regardless, the FFT/DFT Output Analyzer 26 analyzes the FFT/DFT output values \vec{S}_{k,1} . . . \vec{S}_{k,L}_{_{F}} as decision metrics to select from among the corresponding frequency deviation hypotheses \hat{f}₁ . . . \hat{f}_{L}_{_{F}}the hypothesis \hat{f}ₖ that best characterizes the instantaneous frequency deviation for the particular pilot sub-block k.

In one embodiment, for instance, the FFT/DFT Output Analyzer 26 selects the frequency deviation hypothesis \hat{f}ₖ corresponding to the element of \vec{S}ₖ that has the largest absolute value (or absolute value squared).

With this understanding, the frequency deviation estimator 20 in some embodiments is characterized as obtaining periodical estimates of the instantaneous frequency deviation, i.e., according to a periodogram algorithm. In doing so, the frequency deviation estimator 20 effectively implements a maximum likelihood estimator via its FFT or DFT 24 which derotates and sums the receive symbols based on the different frequency hypotheses \hat{f}₁ . . . \hat{f}_{L}_{_{F}}. The estimate then corresponds to the frequency hypothesis that has the largest magnitude.

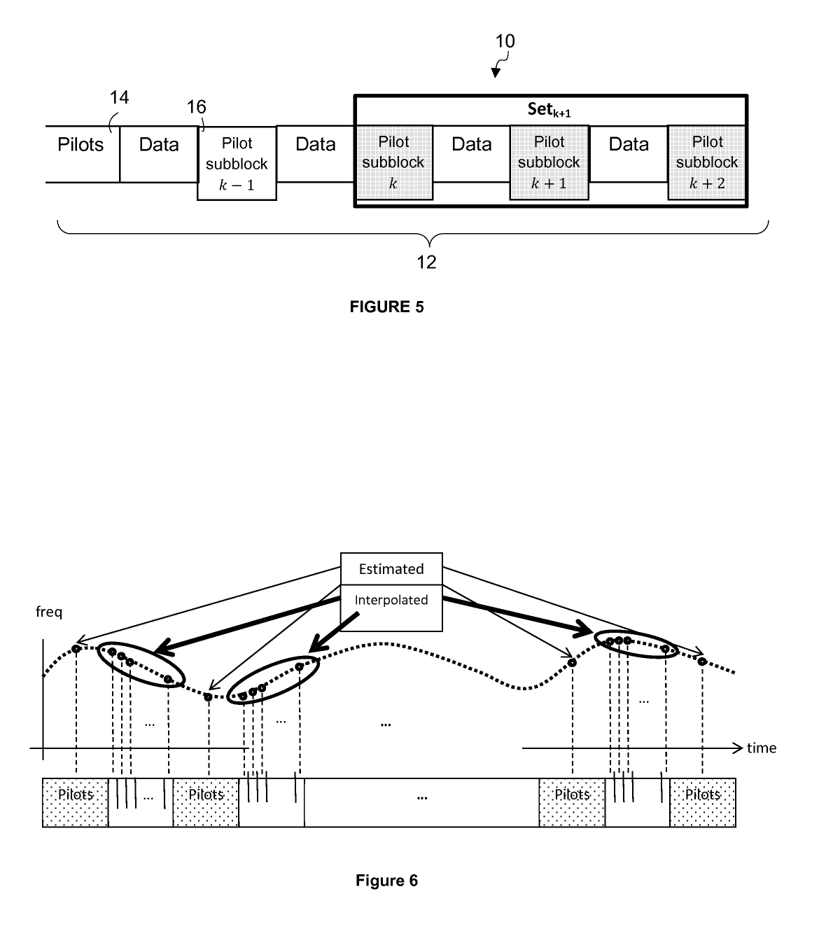

In one or more embodiments, the frequency deviation estimator 20 iterates over the radio block 12 (e.g., in FIG. 1) so as to obtain one instantaneous frequency deviation estimate for each pilot sub-block 14 according to the method 100 described above (e.g., the estimator 20 runs the periodogram algorithm once for each pilot sub-block 14). In this case, the set (i.e., collection) used for different estimates may overlap. Continuing the example in FIG. 3, for instance, the estimator 20 also obtains an instantaneous frequency deviation estimate for pilot sub-block k+1 using a set (Setₖ₊₁) shown in FIG. 5. The estimator thereby iteratively (i.e., repeatedly) obtains instantaneous frequency deviation estimates along the radio block 12 using the distributed pilot symbols. That is, the method 100 in some embodiments entails performing the selecting (Block 110), applying (Block 120), and obtaining (Block 130) for each of multiple non-contiguous pilot sub-blocks 14 in the radio block 12.

In some embodiments, the estimator 20 determines whether the estimated frequency deviations f̅ₖ across the different pilot sub-blocks k=0, 1, 2, . . . are noisy and, if so, filters the estimates {f̅₀, f̅₁, f̅₂ . . . } using one or more filters 28 in order to mitigate that noise. In one embodiment, for instance, the estimator 20 smooths the estimates using a median filter. The operation of median filter of length L is sliding a window of length L over an input signal, and outputs the median value within the window. For example, let the input of a median filter of length-3 be [1 3 8 5 4 9 2], the output is then [1 3 5 5 5 4 2]. Regardless of the particular filtering applied, the estimator 20 selectively applies that filtering as needed (e.g., when the received signal has a low signal-to-noise ratio (SNR), but not when the signal has a high SNR).

Irrespective of whether filtering is applied, though, the distributed nature of the pilot symbols/sub-blocks advantageously improves the accuracy with which instantaneous frequency deviation is estimated for non-pilot symbols (e.g., data symbols). Indeed, in at least some embodiments, the estimator 20 estimates the instantaneous frequency deviation for non-pilot symbols within a radio block 12 from the instantaneous frequency deviation estimates obtained for the pilot symbols/sub-blocks distributed throughout that radio block 12. In one or more embodiments, for instance, the estimator 20 does so by (e.g., linearly) interpolating the non-pilot deviation estimates from the pilot deviation estimates. FIG. 6 illustrates an example of this. Alternatively or additionally to filtering the pilot deviation estimates prior to interpolation, the estimator 20 in some embodiments filters the deviation estimates after interpolation. That is, the estimator 20 determines whether the estimated frequency deviations fₘ for pilots and non-pilots are noisy and, if so, filters the estimates in order to mitigate that noise.

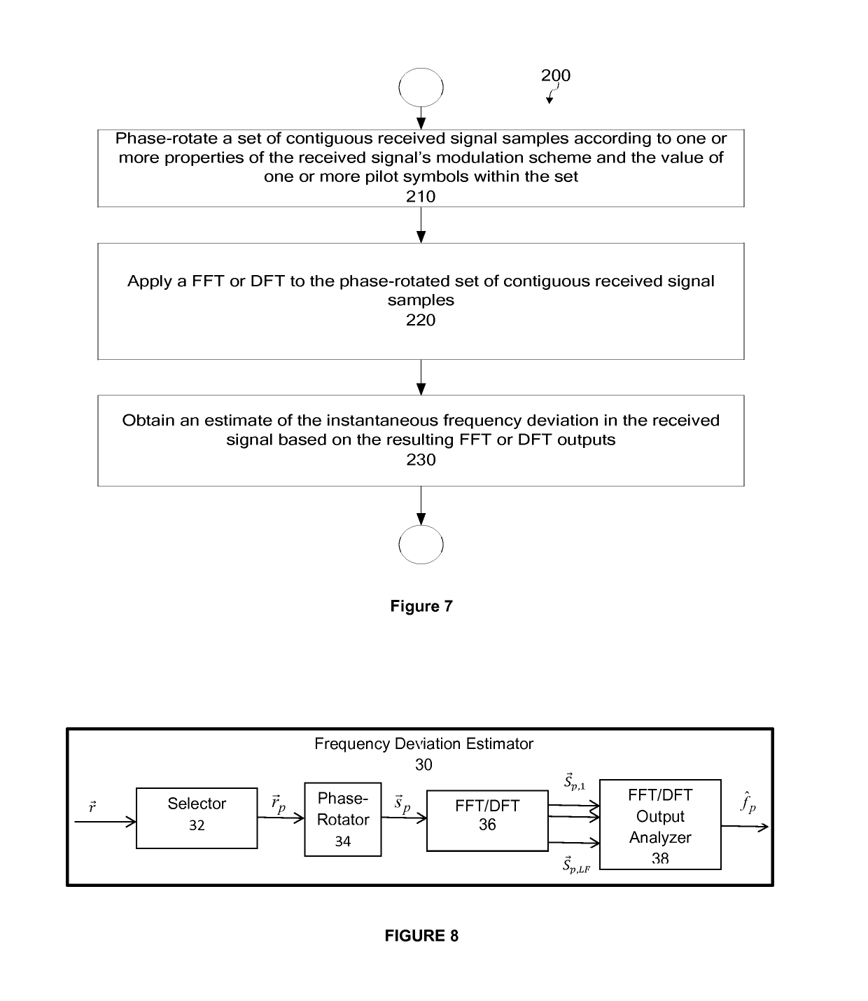

FIG. 7 illustrates a method 200 (e.g., implemented by an estimator of a receiver) for estimating the instantaneous frequency deviation in a received signal according to one or more other embodiments. As shown, the method 200 includes phase-rotating a set of contiguous received signal samples according to one or more properties of the received signal's modulation scheme (e.g., modulation index) and the value of one or more pilot symbols within the set (Block 210). The method 200 also includes applying a FFT or DFT to the set of contiguous received signal samples, as phase-rotated (Block 220). The method 200 further entails obtaining an estimate of the instantaneous frequency deviation in the received signal based on the resulting FFT or DFT outputs (Block 230).

In one or more embodiments, for instance, the modulation scheme is continuous phase shift keying (CPFSK), which is used in Bluetooth Long Range (BLR). In this case, the receive symbols are subjected to accumulative rotation due to the transmitted pilot symbols. The phase rotation in FIG. 7 advantageously removes this accumulative rotation before the FFT or DFT.

In at least some embodiments, the method 200 in FIG. 7 does not rely on a distributed pilot scheme as in FIG. 2. For example, the set of samples used by FIG. 7 to estimate the instantaneous frequency deviation may just include a single pilot sub-block 14 of one or more contiguous pilot symbols, surrounded by data symbols (e.g., a data burst or slot that includes pilot symbols clustered in the middle). FIG. 8 illustrates a frequency deviation estimator 30 of a receiver in this case.

As shown in FIG. 8, the frequency deviation estimator 30 includes a selector 32, a phase rotator 34, an FFT or DFT 36, and an FFT or DFT output analyzer 38.

The selector 32 receives the receive symbol vector as \vec{r}=[\vec{r}_{d,1}, \vec{r}ₚ, \vec{r}_{d,2}]. The selector 32 as shown selects the set of symbols to use for estimating the instantaneous frequency deviation as being the pilot symbols \vec{r}ₚ (i.e., a single pilot sub-block). The phase-rotator 34 phase-rotates the pilot symbols \vec{r}ₚ according to one or more properties of the received signal's modulation scheme (e.g., modulation index) and the pilot symbol values.

For CPFSK, for instance, the phase-rotator 34 rotates the pilot symbols in order to remove the accumulative rotation that the symbols have been subjected to due to the transmitted pilot symbols. Indeed, since the transmitted pilot symbols are known, the phase-rotator 34 removes the accumulative rotation due to them by multiplying the receive symbols in the pilot sub-block by the complex exponential e^{-j2πf}^{_{d}}^{T}^{_{S}}^{c}^{ₚ}⁽ⁿ⁾, where n=1, . . . , L_{P} and L_{P} is the length of the pilot sub-block.

In more detail, the parameters in this complex exponential include f_{d} as the nominal frequency deviation of the CPFSK modulator, T_{S} as the symbol duration, and cₚ(n) as the accumulative sum of the pilot symbols from the beginning of the pilot sub-block up till symbol n. That is cₚ(n)=Σₘ₌₁ⁿp(m), and p(m) is the mth pilot symbol in the sub-block. Two important examples for pilot symbols are: 1) The pilot sub-block consists of an all-one vector. Then cₚ(n)=1, 2, 3, . . . , L_{P}. 2) The pilot sub-block consists of an alternating 1 and −1 vector. Then cₚ(n)=1, 0, 1, 0, . . . Note that for Bluetooth Long Range, the product f_{d}T_{S}=0.25. Therefore e^{-j2πf}^{_{d}}T_{S}cₚ(n)=(−j)^{c}^{ₚ}⁽ⁿ⁾. For example, for the alternating pilot sequence, this becomes the sequence e^{-j2πf}^{_{d}}^{T}^{_{S}}^{c}^{ₚ}⁽ⁿ⁾=(−j)^{c}^{ₚ}⁽ⁿ⁾=−j, 1, j, 1, . . .

Regardless of the particular modulation scheme, though, the FFT/DFT 36 applies a FFT or DFT to the set \vec{r}ₚ as \vec{S}ₚ=FFT_{L}_{_{f}}(\vec{r}ₚ). The applied FFT or DFT has a length L_{F} so as to produce L_{F} output values \vec{S}_{p,1} . . . \vec{S}_{p,L}. In at least some embodiments, the length L_{F} is selected to be sufficiently large (e.g., 1024) to decrease the frequency granularity and improve resolution. In any event, the FFT/DFT Output Analyzer 38 effectively treats each of the L_{F} output values \vec{S}_{p,1} . . . \vec{S}_{p,L}_{_{F}} as decision metrics corresponding respectively to L_{F} frequency deviation hypotheses \hat{f}₁ . . . \hat{f}_{L}_{_{F}}. These frequency deviation hypotheses in at least some embodiments are (−L_{F}/2+1)*df, (−L_{F}/2+2)*df, −df, 0, df, 2df, . . . , (L_{F}/2)*df, where df=Rs/L_{F}, and Rs is the data rate of the received symbols. For Bluetooth Long Range, Rs=1 MHz, and thus df is 1/L_{F} MHz. Regardless, the FFT Output Analyzer 38 analyzes the FFT output values \vec{S}_{p,1} . . . \vec{S}_{p,L}_{_{F}} as decision metrics to select from among the corresponding frequency deviation hypotheses \hat{f}₁ . . . \hat{f}_{L}_{_{F}} the hypothesis \hat{f}ₖ that best characterizes the instantaneous frequency deviation of the received signal.

In one embodiment, for instance, the FFT/DFT Output Analyzer 38 selects the frequency deviation hypothesis \hat{f}ₚ corresponding to the element of \vec{S}ₚ that has the largest absolute value (or absolute value squared).

With this understanding, the frequency deviation estimator 30 in some embodiments is characterized as obtaining periodical estimates of the instantaneous frequency deviation, i.e., according to a periodogram algorithm. In doing so, the frequency deviation estimator 30 effectively implements a maximum likelihood estimator via its FFT or DFT 36 which derotates and sums the receive symbols based on the different frequency hypotheses \hat{f}₁ . . . \hat{f}_{L}_{_{F}}. The estimate then corresponds to the frequency hypothesis that has the largest magnitude.

In some implementations of FIGS. 7 and 8, the estimator 30 assigns the instantaneous frequency deviation estimated for the pilot sub-block also to the non-pilot sub-blocks (e.g., the data sub-blocks) in the radio block.

In still other embodiments, the embodiments in FIGS. 2 and 7 are combined so as to use both distributed pilots as well as phase-rotation as described above. That is, the phase-rotating step 210 in FIG. 7 is applied to the set of contiguous samples in FIG. 2 (before step 120), and the FFT or DFT is applied to the set as phase-rotated.

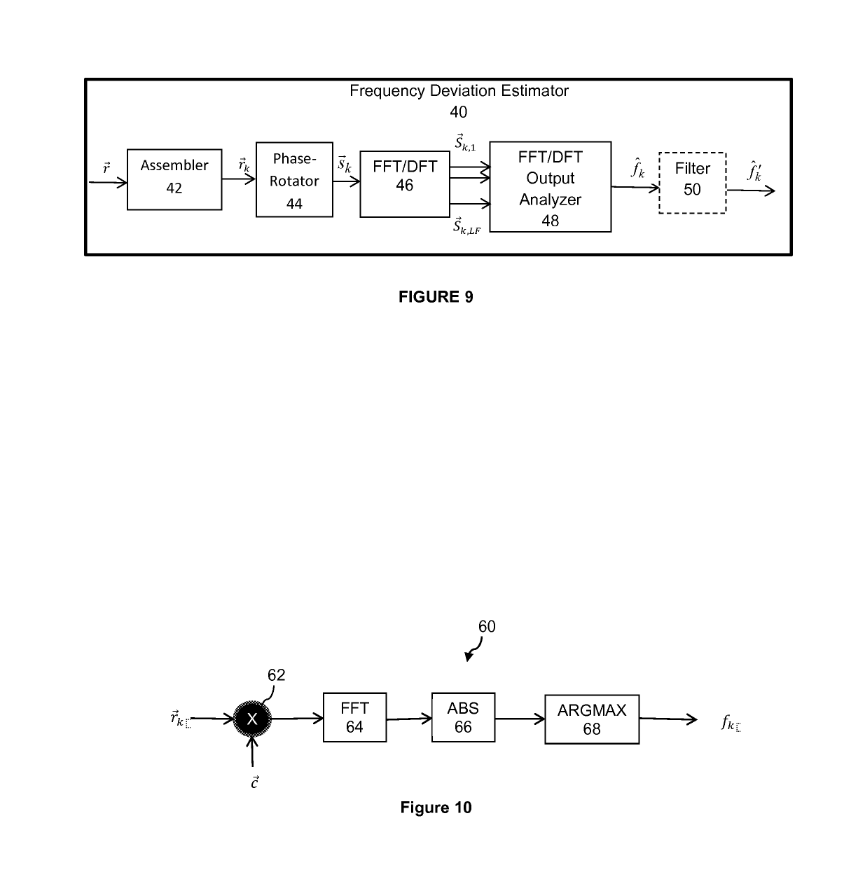

FIG. 9 illustrates one example of this embodiment in which a frequency deviation estimator 40 includes an assembler 42, a phase-rotator 44, an FFT or DFT 46, an FFT/DFT Output Analyzer 48, and optionally one or more filters 50. As shown, the assembler 42 receives the receive symbol vector as \vec{r}=[\vec{r}_{p,1},\vec{r}_{d,1},\vec{r}_{p,2}, \vec{r}_{d,2}, . . . ] and assembles the set \vec{r}ₖ=[\vec{r}_{p,k-N}_{ₚ}, \vec{0} . . . , \vec{0}, \vec{r}_{p,k}, \vec{0}, . . . , \vec{0}, \vec{r}_{p,k+N}_{_{P}}] as described above with respect to FIG. 4. The phase-rotator 44 then phase-rotates \vec{r}ₖ according to one or more properties of the received signal's modulation scheme (e.g., modulation index) and the pilot symbol values. For CPFSK, for instance, the phase-rotator 44 multiplies \vec{r}ₖ, by the complex exponential e^{-j2πf}^{_{d}}^{T}^{_{S}}^{c}^{ₚ}⁽ⁿ⁾. In at least some embodiments, the phase-rotator 44 does so by lumping a sequence of symbols that represents the complex exponential into a vector \vec{c}ₚ . The phase-rotator 44 then multiplies \vec{r}ₖ symbol-by-symbol by the vector \vec{c}=[\vec{c}ₚ, \vec{0}, \vec{c}ₚ, \vec{0}, . . . , \vec{c}ₚ] in order to obtain a phase-rotated set \vec{s}ₖ. That is, \vec{s}ₖ=diag(\vec{r}ₖ^{T}×\vec{c}). Next, the FFT/DFT 46 applies a FFT or DFT to the set \vec{s}ₖ, as phased rotated, according to \vec{S}ₖ=FFT_{L}_{_{f}}(\vec{s}ₖ). The FFT/DFT Output Analyzer 48 then analyzes the FFT/DFT output values \vec{S}_{k,0} . . . S̅_{k,L}_{_{F}} as decision metrics to select from among the corresponding frequency deviation hypotheses \hat{f}₀ . . . \hat{f}_{L}_{_{F}} the hypothesis \hat{f}ₖ that best characterizes the instantaneous frequency deviation for the particular pilot sub-block k. As mentioned above with respect to FIG. 4, the estimator 40 in some embodiments determines whether the estimated frequency deviations f̅ₖ across the different pilot sub-blocks k=0, 1, 2, . . . are noisy and, if so, filters the estimates {f̅₀, f̅₁, f̅₂ . . . } using one or more filters 50 in order to mitigate that noise.

An implementation of the periodogram algorithm for the combined embodiments is illustrated for instance in FIG. 10. As shown, an estimator 60 includes a multiplier 62, an FFT 64, an absolute value function 66, and an argmax function 68. The multiplier 62 performs the above described phase rotation by multiplying the set \vec{r}ₖ of receive signal samples symbol-by-symbol by the vector \vec{c}=[\vec{c}ₚ, \vec{0}, \vec{c}ₚ, \vec{0}, . . . , \vec{c}ₚ] in order to obtain a phase-rotated set \vec{s}ₖ. The FFT 64 then applies the FFT to the set \vec{s}ₖ, as phased rotated, whereupon the ABS function 66 and the argmax function 68 operate to select the frequency deviation hypothesis \hat{f}ₖ corresponding to the FFT output value that has the largest absolute value.

In general, therefore, the combined embodiments effectively include a method of estimating instantaneous frequency deviation in the receive signal. The method includes assembling a collection of selected received samples among all the received samples according to a distributed pilot pattern. The method further includes phase-rotating the collected selected received samples according to one or more modulation properties (e.g., the modulation index) and distributed pilot symbol values. The method also includes applying FFT/DFT on the phase-rotated received samples, and identifying a frequency deviation value based on the FFT outputs. In some embodiments, the method further includes smoothing using a median filter. Alternatively or additionally, the method includes obtaining via interpolation an instantaneous frequency deviation for a data symbol based on plurality of instantaneous frequency deviations, each corresponding to one or more pilot symbols.

Irrespective of the particular approach used to estimate instantaneous frequency deviation, the receiver in at least some embodiments compensates for that deviation. In particular, if the obtained frequency estimates are \hat{f}(m), then the estimated phase at time n is φ(n)=2π×Σₘ₌₀ⁿ\hat{f}(m)×mT_{S}. The compensation for the rotation is then done by multiplying the receive symbols r(n) by e^{-jφ(n)}. This compensation is done in one or more embodiments before passing the receive signal to the frontend demodulator.

Note that estimation herein may be done either in real time or after the reception of a whole radio block 12. Moreover, the estimates may be computed sequentially or in parallel (e.g., if sufficient hardware is available); that is, estimates for different pilot sub-blocks may be obtained in parallel.

Moreover, in iterative demodulation and decoding systems, the estimation accuracy is prone to further improvement if the decoded data symbols are used as quasi-pilots to aid the pilot sub-block(s).

In short, one or more embodiments herein estimate the frequency deviation in the receive signal for the purpose of compensating for this deviation prior to passing the receive signal to the frontend demodulator. The estimation technique in some embodiments depends on a distributed pilot scheme where one estimate is calculated per pilot sub-block using the receive values corresponding to this pilot block as well as a certain number of neighboring pilot blocks. The frequency estimates at the data symbols are obtained in one or more embodiments after that via interpolation and optional filtering.

Those skilled in the art will appreciate that no particular communication standard is required for practicing the above embodiments. As one particular example, though, the embodiments are applicable to Bluetooth or BLR systems.

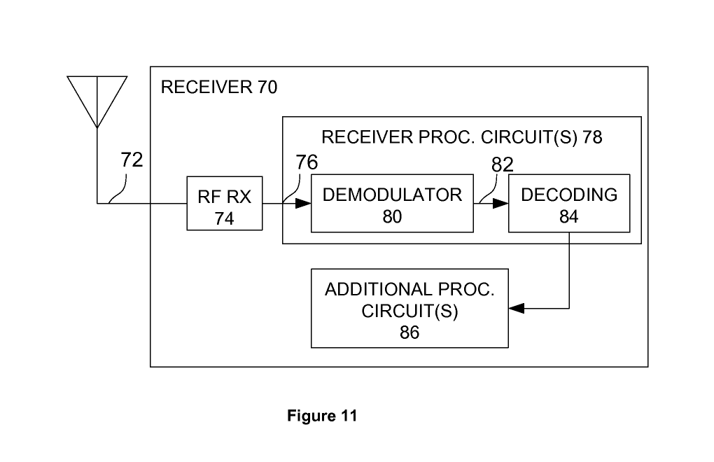

Those skilled in the art will appreciate that FIG. 11 illustrates a receiver 70 that incorporates the frequency deviation estimator according to some embodiments herein. An RF receive signal arrives at an antenna 72 associated with the receiver. The RF receive signal is processed by a front-end RF circuit 74, which mixes the signal down to baseband and digitizes it to form a baseband signal that, in some embodiments, represents the earlier identified receive signal processed in FIGS. 2 and 7. The receive signal values comprising the received signal 76 thus represent or otherwise convey a given sequence of symbols, including pilot and non-pilot sub-blocks 14, 16 within any given radio block 12.

Receiver processing circuits 78 include an embodiment of the frequency deviation estimator (not shown). These processing circuits 82 by way of the frequency deviation estimator estimate and compensate for frequency deviation in the received signal 76 prior to passing the receive signal 76 to the demodulator 80. The demodulated signal 82 (e.g., in the form of soft bit values) is next processed by a decoding circuit 84. The decoding circuit 84 decodes the detected symbols to recover the originally transmitted information. The decoding circuit 84 outputs such information to one or more additional processing circuits 86, for further operations. The nature of the additional processing circuits varies with the intended function or purpose of the receiver 70, e.g., base station circuit, mobile terminal circuit, etc.

The circuits described above may comprise one or more processors, hardware circuits, firmware, or a combination thereof. The receiver 70 in this regard may also comprise memory that includes one or more volatile and/or non-volatile memory devices. Program code for controlling operation of the receiver may be stored in a non-volatile memory, such as a read-only memory or flash memory. Temporary data generated during operation may be stored in random access memory. Program code stored in memory, when executed by a processing circuit, causes the processing circuit to perform the methods shown above.

Embodiments herein thereby further include a computer program comprising instructions, which when executed on at least one processor of a receiver 70, cause the receiver 70 to carry out the method(s) above. Embodiments further include a carrier containing such a computer program, where the carrier is one of an electrical signal, an optical signal, a radio signal, or a computer readable storage medium.

Of course, all of the foregoing description and the accompanying drawings represent non-limiting examples of the methods, individual apparatuses, and computer programs and computer program products taught herein. As such, the present invention is not limited by the foregoing description and accompanying drawings. Instead, the present invention is limited only by the following claims and their legal equivalents

1-26. (canceled)

27. A method for estimating an instantaneous frequency deviation in a received signal that includes pilot sub-blocks non-contiguously distributed in time across a radio block, each pilot sub-block comprising one or more pilot symbols, wherein the method comprises:
selecting, from the pilot sub-blocks non-contiguously distributed in time across the radio block, a particular pilot sub-block for which to obtain an instantaneous frequency deviation estimate;
applying a Fast Fourier Transform (FFT) or a Discrete Fourier Transform (DFT) to a set of contiguous received signal samples that spans multiple ones of the pilot sub-blocks, including the particular pilot sub-block as well as one or more assisting pilot sub-blocks neighboring that particular pilot sub-block; and
obtaining an instantaneous frequency deviation estimate for the particular pilot sub-block based on the resulting FFT or DFT outputs.

28. The method of claim 27, further comprising dynamically controlling an accuracy of the instantaneous frequency deviation estimate for the particular pilot sub-block by dynamically selecting at least one of:
the number of the one or more assisting pilot sub-blocks;
a size of the FFT or DFT; and
a length of each pilot sub-block.

29. The method of claim 28, wherein the dynamic selection is performed based on comparing a length of the particular pilot sub-block to a previous estimate of instantaneous frequency deviation in the received signal.

30. The method of claim 27, wherein the one or more assisting pilot sub-blocks comprises multiple assisting pilot sub-blocks centered around the particular pilot sub-block in time, including at least one assisting pilot sub-block on each side of the particular pilot sub-block.

31. The method of claim 27, wherein the instantaneous frequency deviation estimate for the particular pilot sub-block is a periodical estimate that is obtained according to a periodogram algorithm.

32. The method of claim 27, wherein the method comprises obtaining an instantaneous frequency deviation estimate for each of multiple non-contiguous pilot sub-blocks in the radio block, by performing the selecting, the applying, and the obtaining for each of those pilot sub-blocks.

33. The method of claim 32, wherein the method comprises interpolating, from the instantaneous frequency deviation estimates obtained for the multiple non-contiguous pilot sub-blocks, an instantaneous frequency deviation estimate for each of one or more non-pilot sub-blocks that are interlaced in time between those multiple non-contiguous pilot sub-blocks.

34. The method of claim 27, wherein the method comprises smoothing instantaneous frequency deviation estimates obtained for sub-blocks in the radio block using a median filter.

35. The method of claim 27, wherein:
the method comprises phase-rotating the set of contiguous received signal samples according to one or more properties of the received signal's modulation scheme and a value of one or more pilot symbols within the set; and
wherein the applying comprises applying the FFT or DFT to the set, as phase rotated.

36. The method of claim 35, wherein the phase-rotating comprises determining a phase by which to rotate a received signal sample based on a nominal frequency deviation or nominal modulation index of the received signal's modulation scheme.

37. The method of claim 27:
wherein the applying produces L_{F}FFT or DFT output values \vec{S}_{k,1} . . . \vec{S}_{k,L}corresponding respectively to L_{F} frequency deviation hypotheses \hat{f}₁ . . . \hat{f}_{L}_{_{F}}, where the frequency deviation hypotheses respectively equal (−L_{F}/2+1)*df, (−L_{F}/2+2)*df, . . . , −df, 0, df, 2df, . . . , (L_{F}/2)*df, where df=Rs/L_{F}, and Rs is the data rate of the received symbols; and
wherein the obtaining comprises selecting from the frequency deviation hypotheses the hypothesis corresponding to the output value that has the largest absolute value or absolute value squared.

38. The method of claim 37, further comprising compensating for the estimated instantaneous frequency deviation in the received signal and outputting the compensated signal to a frontend demodulator.

39. The method of claim 27, wherein the received signal is a Bluetooth Long Range (BLR) signal.

40. A method for estimating an instantaneous frequency deviation in a received signal, the method comprising:
phase-rotating a set of contiguous received signal samples according to one or more properties of the received signal's modulation scheme and a value of one or more pilot symbols within the set;
applying a Fast Fourier Transform (FFT) or a Discrete Fourier Transform (DFT) to the set of contiguous received signal samples, as phase rotated; and
obtaining an instantaneous frequency deviation estimate in the received signal based on the resulting FFT or DFT outputs.

41. The method of claim 40, wherein the one or more properties include a modulation index of the received signal's modulation scheme.

42. The method of claim 40, wherein the modulation scheme is continuous phase frequency shift keying (CPFSK).

43. The method of claim 42:
wherein the one or more pilot symbols are indexed in order with an index n; and
wherein the phase-rotating comprises multiplying the set by a complex exponential e^{-j2πf}^{_{d}}^{T}^{_{S}}^{c}^{ₚ}⁽ⁿ⁾, where f_{d} is a nominal frequency deviation of an CPFSK modulator, T_{S} is a duration of any given symbol in the set, and cₙ(n) is an accumulative sum of the value of the one or more pilot symbols up until symbol n.

44. The method of claim 40:
wherein the applying produces L_{F} FFT or DFT output values \vec{S}_{k,1} . . . \vec{S}_{k,L}_{_{F}} corresponding respectively to L_{F} frequency deviation hypotheses \hat{f}₁ . . . \hat{f}_{L}_{_{F}}, where the frequency deviation hypotheses respectively equal (−L_{F}/2+1)*df, (−L_{F}/2+2)*df, . . . , −df, 0, df, 2df, . . . , (L_{F}/2)*df, where df=Rs/L_{F}, and Rs is the data rate of the received symbols; and
wherein the obtaining comprises selecting from the frequency deviation hypotheses the hypothesis corresponding to the output value that has the largest absolute value or absolute value squared.

45. The method of claim 44, further comprising compensating for the estimated instantaneous frequency deviation in the received signal and outputting the compensated signal to a frontend demodulator.

46. The method of claim 40, wherein the received signal is a Bluetooth Long Range (BLR) signal.

47. A frequency deviation estimator for estimating an instantaneous frequency deviation in a received signal, wherein the frequency deviation estimator comprises a processing circuit configured to:
select, from the pilot sub-blocks non-contiguously distributed in time across the radio block, a particular pilot sub-block for which to obtain an instantaneous frequency deviation estimate;
apply a Fast Fourier Transform (FFT) or a Discrete Fourier Transform (DFT) to a set of contiguous received signal samples that spans multiple ones of the pilot sub-blocks, including the particular pilot sub-block as well as one or more assisting pilot sub-blocks neighboring that particular pilot sub-block; and
obtain an instantaneous frequency deviation estimate for the particular pilot sub-block based on the resulting FFT or DFT outputs.

48. The frequency deviation estimator of claim 47, wherein the processing circuit is further configured to:
phase-rotate the set of contiguous received signal samples according to one or more properties of the received signal's modulation scheme and a value of one or more pilot symbols within the set; and
apply the FFT or DFT to the set, as phase rotated.

49. A frequency deviation estimator for estimating an instantaneous frequency deviation in a received signal, wherein the frequency deviation estimator comprises a processing circuit configured to:
phase-rotate a set of contiguous received signal samples according to one or more properties of the received signal's modulation scheme and a value of one or more pilot symbols within the set;
apply a Fast Fourier Transform (FFT) or a Discrete Fourier Transform (DFT) to the set of contiguous received signal samples, as phase rotated; and
obtain an instantaneous frequency deviation estimate in the received signal based on the resulting FFT or DFT outputs.

50. A receiver, comprising:
a frequency deviation estimator;
wherein the frequency deviation estimator comprises a processing circuit configured to:
select, from the pilot sub-blocks non-contiguously distributed in time across the radio block, a particular pilot sub-block for which to obtain an instantaneous frequency deviation estimate;
apply a Fast Fourier Transform (FFT) or a Discrete Fourier Transform (DFT) to a set of contiguous received signal samples that spans multiple ones of the pilot sub-blocks, including the particular pilot sub-block as well as one or more assisting pilot sub-blocks neighboring that particular pilot sub-block; and
obtain an instantaneous frequency deviation estimate for the particular pilot sub-block based on the resulting FFT or DFT outputs.

51. A computer program product stored in a non-transitory computer readable medium for estimating an instantaneous frequency deviation in a received signal that includes pilot sub-blocks non-contiguously distributed in time across a radio block, each pilot sub-block comprising one or more pilot symbols, the computer program product comprising software instructions which, when run on a processing circuit of a frequency deviation estimator, causes the frequency deviation estimator to:
select, from the pilot sub-blocks non-contiguously distributed in time across the radio block, a particular pilot sub-block for which to obtain an instantaneous frequency deviation estimate;
apply a Fast Fourier Transform (FFT) or a Discrete Fourier Transform (DFT) to a set of contiguous received signal samples that spans multiple ones of the pilot sub-blocks, including the particular pilot sub-block as well as one or more assisting pilot sub-blocks neighboring that particular pilot sub-block; and
obtain an instantaneous frequency deviation estimate for the particular pilot sub-block based on the resulting FFT or DFT outputs.

52. A computer program product stored in a non-transitory computer readable medium for estimating an instantaneous frequency deviation in a received signal, the computer program product comprising software instructions which, when run on a processing circuit of a frequency deviation estimator, causes the frequency deviation estimator to:
phase-rotate a set of contiguous received signal samples according to one or more properties of the received signal's modulation scheme and a value of one or more pilot symbols within the set;
apply a Fast Fourier Transform (FFT) or a Discrete Fourier Transform (DFT) to the set of contiguous received signal samples, as phase rotated; and
obtain an instantaneous frequency deviation estimate in the received signal based on the resulting FFT or DFT outputs.
